(19) United States
(12) Patent Application Publication
(10) Pub. No.: US 2005/0170870 A1
(43) Pub. Date: Aug. 4, 2005

(54) Sports communication system

(75) Inventors: Nir Goldenberg, Holon (IL); Eli Shmul, Bat Yam (IL)

Correspondence Address: DENNISON, SCHULTZ, DOUGHERTY & MACDONALD, 1727 KING STREET, SUITE 105, ALEXANDRIA, VA, 22314, US

(73) Assignee: Oren KOBY, one third interest

(21) Appl. No.: 11/090,250

(22) Filed: Mar. 28, 2005

Related U.S. Application Data
(63) Continuation-in-part of application No. PCT/IL03/00761, filed on Sep. 24, 2003.

(30) Foreign Application Priority Data
Sep. 27, 2002 (IL) 151969

(51) Int. Cl. A43B 5/04; H04B 1/38; H04M 1/00

(52) U.S. Cl. 455/575.2; 455/90.1

(57) ABSTRACT

The present invention is of a communication system for use in sports training or during play, wherein a first user can communicate on a real time basis with at least one second user, wherein the system includes at least one digital transmitter module for readily facilitating transferring a verbal message from a first user to at least one second user, and at least one digital receiving module for readily facilitating the second user receiving the verbal message from the first user. Preferably, the transmitter is used by the first user, such as a trainer, for real time communication with at least one second user, such as a player during a game, via a receiving device worn by the player. Optionally, the system includes a multi-user activator for transmitting to more than one user.

### FIELD AND BACKGROUND OF THE INVENTION

The present invention relates to a sports communication system. In particular, it concerns a sports communication system featuring a training aid, which includes a transmitter and at least one receiving device. Moreover, the preset invention is of a communication system for use in sports training or during play, wherein a first user, such as a trainer can communicate real time with at least one second user.

Presently, communication between players and a trainer during a game or match is very limited. Methods of the prior art are limited to the trainer waiting until there is a break in play and/or alternatively shouting instructions from the sidelines. The disadvantages of the current methods include the following. It is difficult for a trainer to relay strategies and plays to moving players. Furthermore, the trainer is unable to correct players' mistakes during play. In addition, in the event that the opposing team or sportsperson is aware of the pre-designated plan of play, a trainer is unable to communicate to the players a new plan.

Currently, there is no sports communication device for real time interchange between a first user and a second user, such as a trainer out of eye contact from the first user, while the player is involved in a game.

There is therefore a need for a communication system, whereby a trainer or a first user can communicate at any time with a second user, such as disclosed in the present invention. Such a communication system provides a solution to the aforementioned problems.

### SUMMARY OF THE INVENTION

The present invention relates to a sports communication system. Moreover, the present invention is of a communication system comprising a training aid for use by a first user, which includes a transmitter or transferring a verbal message and at least one receiving device for use by at least one second user for receiving a verbal message. Preferably, the transmitter is used by at least one first user, such as a trainer for communication real time with at least one second user, such as a player during a game, via a receiving device worn by the at least one player.

In a first embodiment the present invention provides a sports communication system comprising (a) at least one transmitter for readily facilitating transferring a verbal message from a first user to at least one second user, and (b) at least one receiving device for readily facilitating the at least one second user receiving the verbal message from the first user.

In a second embodiment the present invention provides a one-way sports communication system comprising (a) at least one transmitter for readily facilitating transferring a verbal message from a first user to at least one second user, and (b) at least one receiving device for readily facilitating the at least one second user receiving the verbal message from the first user.

In a third embodiment the present invention provides a sports communication system comprising (a) at least one transmitter for readily facilitating transferring a verbal message from a first user to at least one second user, wherein the transmitter includes; (i) an electronic board featuring a plurality of buttons; and (ii) an antenna; and (b) at least one device, for readily facilitating the at least one second user receiving the verbal message from the first user wherein the receiver includes an ear piece.

In a fourth embodiment the present invention providers a two way communication system comprising (a) at least one transmitter for use by a user readily facilitating a verbal message from a user to at least one second user, and (b) at least one receiving device for use by a user for readily facilitating receiving the verbal message from the user.

In a preferred embodiment the transmitter further includes a plurality of activators.

In a preferred embodiment the plurality of activators is selected from the group consisting of buttons, switchers, touch activated points and a combination thereof.

In a preferred embodiment the plurality of activators correspond to specific second users.

In a preferred embodiment the plurality of activators includes a multi-channel transmitter.

In a preferred embodiment the transmitter further includes an antenna.

In a preferred embodiment the at least one receiving device is wireless.

In a preferred embodiment the at least one receiving device is selected from the group consisting of, a headphone device, earpiece, device which translates vibration of the cheekbone or a combination thereof

In a preferred embodiment the at least one receiving device further includes a hearing device.

In a preferred embodiment the at least one receiving device further includes a mouth piece.

In a preferred embodiment the first user is a trainer.

In a preferred embodiment the first user is captain of a team.

In a preferred embodiment the first user is a computer.

In a preferred embodiment the at least one second user is a member of a sports team.

In a preferred the sports communication system is for use in any sports game.

In a preferred embodiment the sports communication system is for use in any sports game wherein a subcomponent of a team is not visible by all team members.

The term ‘game’ as used herein includes, but is not limited to, any sport outdoor or indoor activities or any contest with rules, wherein the result is determined by skill, which includes a sports game and any game which involves use of a ball, a competitive activity involving skill, chance or endurance and played according to a set of rules for the amusement of the players or spectators and in addition a single occasion of such an activity or a division of one. Wherever the term ‘game’ is used in the specification, it is envisioned that any suitable game is intended.

The term ‘player’ as used herein includes, but is not limited to, any individual participating in a game irrespective whether the player is a skilled, or unskilled, amateur or professional player. Furthermore, the term ‘player’ as used-herein includes, but is not limited to, a person who takes part or is skilled in some game or sport

The term ‘trainer’ as used her includes, but is not limited to, any individual professional or amateur who teaches and improves the game play of a player, such as, but not limited to instructing players in the techniques, maneuvers, tactics, rules, skills and team interaction of a game, a person or thing that as, such as training athletes.

The term ‘play’ as used herein includes, but is not limited to, any part or all of the execution of a game and involves strategy, maneuvers and skill, an action or conduct of a game, an act or instance of playing and/or a manner or style of play.

### BRIEF DESCRIPTION OF THE DRAWINGS

The invention is herein described, by way of example only, with reference to the accompanying drawing, wherein:

FIG. 1 shows a block diagram of the communication system of the present invention; and

FIG. 2 shows a schematic view of a preferred embodiment of the communication system of the present invention; and

FIG. 3 is a schematic illustration of a sports communication system constructed and operative in accordance with an alternative embodiment of the present invention; and

FIG. 4 is a schematic illustration of a transmitter module according to another embodiment of the invention.

The present invention is a sports communication system. More specifically, the present invention is a one-way sports communication system, wherein a first user has a training aid, which includes a transmitter, for transferring verbal messages and at least one second user has a receiver for receiving the verbal message from a first user. In addition, the present invention provides a two-way sports communication system, wherein a first user has a training aid, which includes a transmitter, for transferring verbal messages and at least one second user has a receiver for receiving the verbal message from a first user and a means for hands free voice activated response. Optionally, the present invention is of a two-way sports communication system, wherein a first user has a training aid, which includes a transmitter, for transferring verbal messages and a receiver for receiving verbal messages and at least one second user has a receiver for receiving the verbal message from a first user and a transmitter for transmitting a verbal message.

The sports communication system of the present invention is geared towards a multiplicity of different users including, but not limited to, any sport which includes more than one player, with or without a trainer and any sport which includes one player and a trainer. It is envisioned that the sports communication system of the present invention will find use in the training of professional and amateur players and in sports matches to achieve best results.

The principles and operation of a sports communication system, according to the present invention may be better understood with reference to the drawings and the accompanying description. The figures are not limiting.

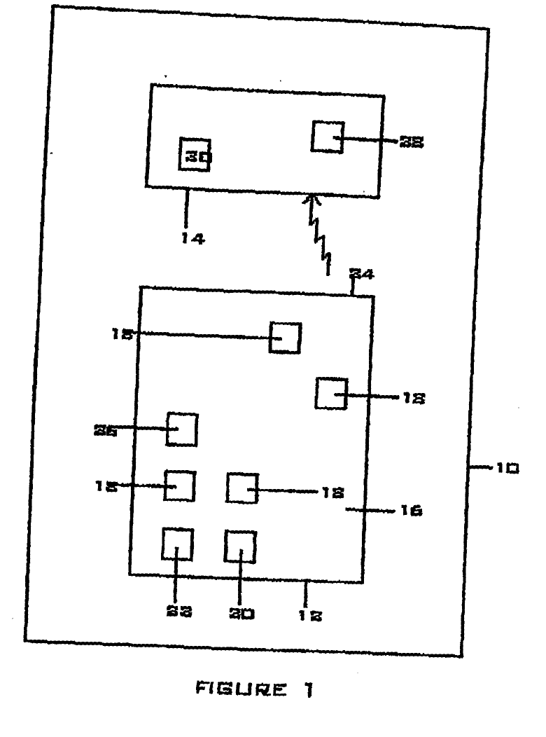

FIG. 1 shows a block diagram of the communication system of the present invention. As can be see in FIG. 1, the sports communication system 10 of the present invention preferably features a transmitter 12 and at least one receiver module 14. Preferably, the sports communication system 10 of the present invention is used by a first user and at least one second user. Preferably, transmitter 12 is wireless. Preferably, transmitter 12 features a panel 16 with a plurality of activators is, here shown as seven activators 18. Preferably, one activator 18 is associated with each user, as by user address or transmission frequency. In this case, activators 18 may be numbered to correspond with specific users.

Preferably, activators 18 are selected from the group consisting of buttons, switches, touch activated points or any combination thereof.

Optionally, a multi user activator 20 is configured to transmit to more than receiver module 14. Preferably, a “burst” activator 22 is configured to transmit to all users, substantially simultaneously. Optionally, transmitter 12 includes an antenna 24.

More preferably, transmitter 12 also includes a processor 26 for processing the transmissions, which processor 26 readily facilitates transferring the transmissions to an associated receiver module 14. Transmitter 12, panel 16 and activators 18, multi user activator 20 and “burst” activator 22 are made from any suitable material.

Preferably, receiver module 14 is any suitable wireless receiving device configured to receive transmissions, such as, but not limited to, a headphone device, an earpiece or a device which transfers vocal messages with vibration of the cheekbone.

Preferably, receiver module 14 includes a hearing device 28 readily facilitating the transmitted message to be heard by the at least one second user. In a more preferred embodiment, receiver module 14 is a wireless earpiece device. Preferably, receiver module 14 is lightweight and not cumbersome, in order not to interfere with the activity of the user.

Optionally, the receiver module 14 includes a transmitter 30, which facilitates the second user wearing receiver module 14 to reply to a transmitted message or to transmit a message.

Preferably, the first user is a trainer or captain of a team. Preferably, at least one second user is a subcomponent of a team, who is not in earshot or eye contact with the first user, or a subcomponent of a team in motion. Optionally, the first user can be a computer configured to instruct a sports team.

Preferably, the sports communication system of the present invention 10 is a one-way system in which a first user transmits a message to at least one second user, but the at least one second user is unable to reply.

In an alternative embodiment, the sports communication system 10 of the present invention provides a two way system, wherein a first user transmits a message to at least one second user and at least one second user can reply, preferably by way of a hands free voice activated system.

Furthermore, the sports communication system 10 of the present invention provides a two way system wherein a user, such as the captain of a team, can transmit instructions.

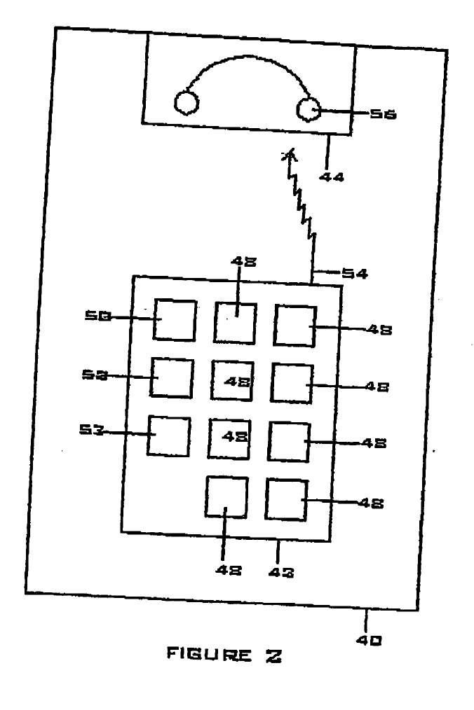

FIG. 2 shows a schematic view of a preferred embodiment of the communication system of the present invention. As can be see in FIG. 2, the sports communication system 40 of the present invention preferably features a transmitter module 42 and at least one receiver module 44. Preferably, the sports communication system 40 of the present invention is used by a first user and at least one second user.

Preferably, transmitter module 42 is wireless. Preferably, transmitter module 42 features a panel 46 with a plurality of activators 48. Preferably, plurality of activators 48 include an activator 48 for each user.

Preferably, activators 48 are numbered to correspond with specific users. Preferably, activators 48 are selected from the group consisting of buttons, switches, touch activated points or a combination thereof.

Optionally, a multi user activator 50 is configured to transmit to more than one user. Preferably, a “burst” activator 52 is configured to facilitate multi-channel transmission in order to transmit to all users.

Preferably, transmitter module 42 includes an antenna 54. More preferably, transmitter module 42 includes a processor 53 for processing transmissions, which processor 53 readily facilitates transferring transmissions to a receiver module 44. Transmitter module 42, panel 46 activator 48, multi user activator 50, “burst” activator 52 are made from any suitable material,

Preferably, receiver module 44 is a headphone wireless receiving device, configured to receive transmissions. Preferably, receiver module 44 includes a hearing device 56, such as a speaker or a vibration patch, readily facilitating the transmitted message to be heard by the second user wearing receiver module 44. Preferably, receiver module 44 is lightweight and not cumbersome, in order not to interfere with the activity of the user.

Preferably, the first user is a trainer or captain of a team. Preferably, at least one second user is a subcomponent of a team. It will be appreciated that the second user may or may not be within earshot or in eye contact with the first user, or may be a subcomponent of a team in motion. Optionally, the first user can be a computer configured to instruct a sports team.

Preferably, the sports communication system 40 of this embodiment is a one-way system in which a first user transmits a message to at least one second user, but the at least one second user is unable to reply.

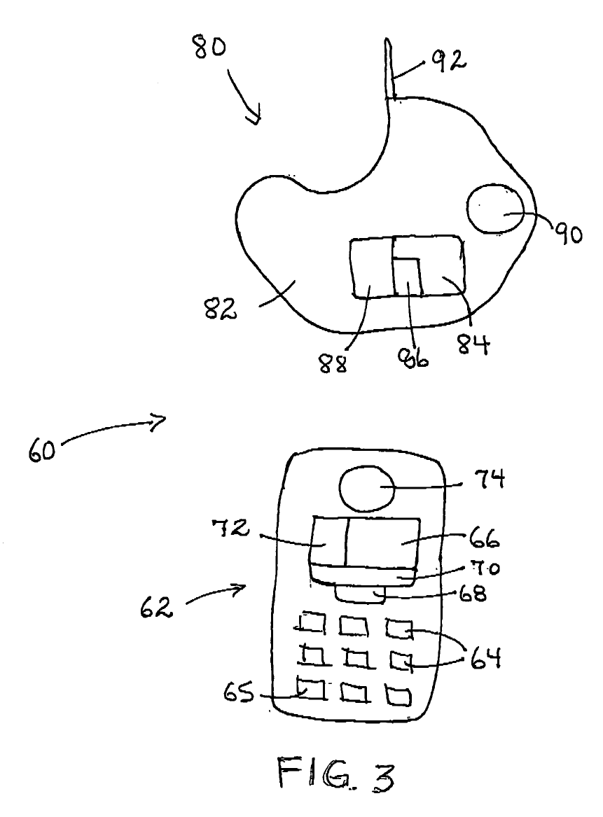

Referring now to FIG. 3, there is shown a schematic illustration of a sport communication system 60 constructed and operative in accordance with another alternative embodiment of the present invention. Sport communication system 60 includes a transmitter module 62 and a receiving module 80. Transmitter module 62 includes a plurality of activators 64, a transmitter 66, a microphone 68, and a power source 70, such as a battery. Microphone 68 is coupled to a controller 72, having an analog to digital converter, to convert voice signals from the first user to digital signals for transmission. Controller 72 may be a processor or discrete logic. If desired, transmitter 66 may be a transceiver, and a speaker 74 or other device for providing an audible signal may be provided to permit two-way communication. In this case, the transceiver preferably includes a digital to analog converter to convert received digital signals back to the voice message for playing audibly to the first user.

Receiving module 80 includes an earpiece 82, preferably shaped and adapted to fit within the ear of a second user (shown enlarged in FIG. 3). Earpiece 82 includes a receiver 84, for receiving digital signals corresponding to the first user's verbal message from transmitter module 62, with a controller 86 with an analog-to-digital converter for converting the received digital signals back to the original verbal message for hearing by the second user. Controller 86 may be a processor or discrete logic. Preferably earpiece 82 is designed to be water resistant or waterproof and does not interfere with the balance of the user wearing it. It will be appreciated that since the earpiece is digital, there is little danger of radiation.

One example of a suitable system is a simplex voice network system (SVNS). The electronic transmitter module and electronic receiver module include SVNS controller cards. The electronic units may be based on an RF transmitter and multiple receiver earphones, which work as a network style system. The transmitter may include power amplification for increased transmission power. The transmitter controller card may be configured, for example, for wireless audio transmission of 100-200 mW, to achieve a range of about 100-200 meters in an open area. Alternatively, the card may be configured for any other desired transmission range, The transmitter may include an omni-directional antenna. The receiver card is enclosed in a small earphone which, preferably, can be inserted entirely in the ear, except for a small external omni-directional antenna The transmitter may support digital transmission of the voice signals including a destination address for each earphone. Each receiver card has its own address, as well as the ability to enable a common address for broadcasting mode support.

The earpiece further includes a device 88 for producing an audible message, such as a miniature speaker or vibration device. A miniature power supply 90, such as a battery, is provided in earpiece 82 to power the other elements thereof. According to one embodiment, receiving module 80 also includes an antenna 92, which may be located outside the ear of the second user. According to another embodiment, the receiver 84 may be a transceiver, and a microphone (not shown), or other device for receiving an audible message from the second user, is provided in the receiving module 80 for two-way communication.

It is a particular feature of this embodiment of the present invention that the earpiece 80 is miniaturized, so as to seat within the ear of a second user, in the manner of a conventional hearing aid, and does not interfere with the balance of the user wearing it. Furthermore, the digital design minimizes danger from radiation.

This embodiment of the invention preferably utilizes wireless transmission, which may be RF. Each receiving module 80 (associated with a particular second user) is assigned a unique address in the transmitter, and this address is associated with one of the activators 64. In this way, a verbal message spoken by the first user into transmitter module 62, as via microphone 68, is converted in the controller 72 to the appropriate digital signals. When the first user presses one of the actuators 64, these digital signals are transmitted to the receiving module 80 having the address associated with that actuator. In the event that the first user wishes to broadcast a single message simultaneously to a group of second users, a separate activator 65 may be provided for “burst” or network-type transmission to the pre-defined group of addresses. Alternatively, the transmitter module 62 may be designed to permit transmission to a selected group of second users which was not defined in advance.

Alternatively, each receiving module 80 may be assigned a unique radio frequency on which transmitter 66 transmits verbal messages meant only for it. In this case, the “burst” activator 65 may provide multi-channel transmission over the relevant frequencies. Alternatively, each receiving module 80 may be assigned one unique channel or address and one group channel or address, and “burst” transmissions will be broadcast over the group channel to all the receiving modules.

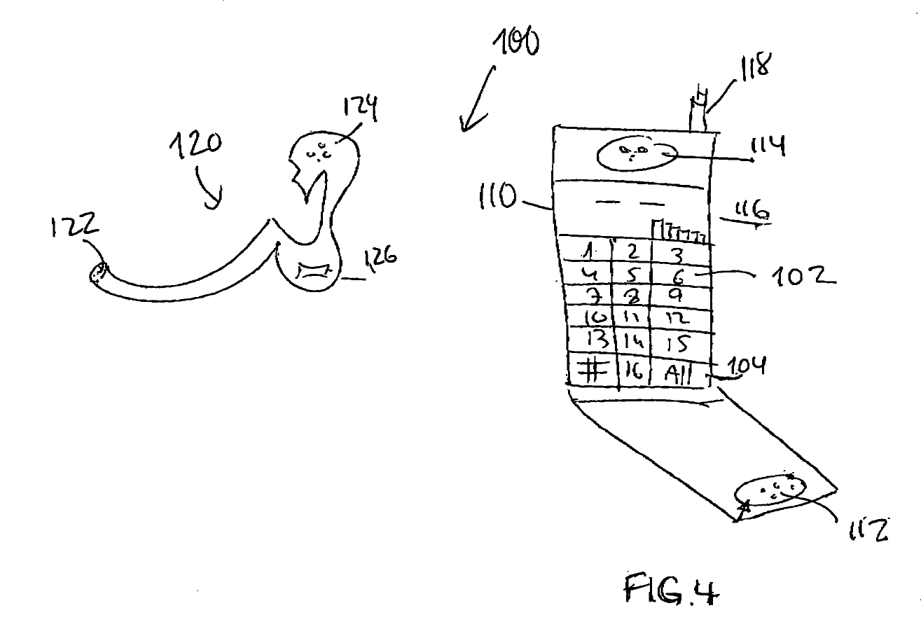

Referring now to FIG. 4, there is shown a schematic illustration of a transmitter module 100 according to an alternative embodiment of the invention. Transmitter module 100 is substantially similar to transmitter module 62, and includes individual activators 102, a group activator 104, and an internal power source (not shown). Transmitter module 100 may include a handset 110 only, or a handset with an earpiece 120. Handset 110, particularly if used alone, includes a microphone 112 and an optional speaker 114. A screen 116 may be provided to permit the first user to view the destination of the transmissions so as to verify that the transmission will be sent to the desired second user. An internal or external antenna 118 is also provided

In order to permit the trainer to speak freely, without having to lift the transmitter module to his ear, a separate earpiece 120 may be provided. Earpiece 120 may be substantially similar to conventional one-piece microphones, and includes a microphone 122, a speaker 124 or other means of permitting the wearer to hear a verbal message, and a battery 126. Verbal messages from microphone 122 are received in a transceiver in handset 110 and, when the appropriate button is pressed, the message is transmitted to the desired receiving module.

It will be appreciated that the above descriptions are intended only to serve as examples, and that many other embodiments are possible wit the spirit and the scope of the present invention. It will further be appreciated that the invention is not limited to what has been described hereinabove merely by way of example. Rather, the invention is limited solely by the claims which follow.

1. A sports communication system comprising:
(a) at least one digital transmitter module for readily facilitating transferring a verbal message from a first user to at least one second user in real time while said at least one second user is playing a sport; and
(b) at least one digital receiving module for readily facilitating said at least one second user receiving said verbal message from said first user, said at least one receiving module being adapted and configured to be worn by said second user.

2. The sports communication system of claim 1, wherein said at least one transmitter module is adapted and configured to convert an analog verbal message to digital signals.

3. The sports communication system of claim 2, wherein said at least one receiving module is adapted and configured to convert digital signals to an analog verbal message.

4. The sports communication system of claim 1, wherein said plurality of activators is selected from the group consisting of buttons, switches, touch activated points, and a combination thereof.

5. The sports communication system of claim 1, wherein each of said plurality of activators corresponds to a specific second user.

6. The sports communication system of claim 1, wherein one of said plurality of activators activates a multi-channel transmitter.

7. The sports communication system of claim 1, wherein said at least one receiving module includes a wireless receiving device.

8. The sports communication system of claim 7, wherein said at least one receiving module is selected from the group consisting of a headphone device, an earpiece, a device which transfers vocal messages wit vibration of a cheekbone of said second user, or a combination thereof.

9. The sports communication system of claim 1, wherein said system is based on a simplex voice network system (SVNS), and said transmitter controller and said receiver controller include SVNS controller cards.

10. The sports communication system of claim 1, wherein said at least one receiving module farther comprises means for providing a verbal response.

11. The sports communication system of claim 10, wherein said means for providing a verbal response includes a device for providing a hands free voice activated response.

12. The sports communication system of claim 1, wherein said first user is a computer configured to instruct a sports team.

13. The sports communication system of claim 1, for use in any sports game wherein a subcomponent of a team is not visible by all team members.

14. The sports communication system of claim 1, wherein said receiving module is assigned a unique individual address or channel, and a group address or channel.

15. A sports communication system comprising:
(a) at least one digital transmitter module for readily facilitating transferring a verbal message from a first user to at least one second user in real time while said at least one second user is playing a sport, wherein said transmitter module comprises:
(i) an electronic board including a plurality of activators;
(ii) an antenna, and
(iii) an analog to digital converter; and
(b) at least one digital receiving module for readily facilitating said at least one second user receiving said verbal message from said first user, said at least one receiving device being adapted and configured to be worn by said second user, wherein said receiving module comprises a digital to analog converter.

16. A method for providing communication comprising:
(a) providing a digital transmitter module to a first user for readily facilitating transferring a verbal message from said first user to at least one second user in real time while said at least one second user is playing a sport, and
(b) providing to said at least one second user a digital receiving module adapted and configured to be worn by said second user, for readily facilitating receiving said verbal message from said first user.
